(19) United States
(12) Patent Application Publication
(10) Pub. No.: US 2022/0225739 A1
(43) Pub. Date: Jul. 21, 2022

(54) METHOD FOR MANUFACTURING CUSTOM ORDER SHOES

(71) Applicant: KITAI CO., LTD., Kashiba-shi, Nara (JP)

(72) Inventor: Terumasa KITA, Kashiba-shi (JP)

(21) Appl. No.: 17/596,620

(22) PCT Filed: Aug. 6, 2020
(86) PCT No.: PCT/JP2020/030262

§ 371 Date: Dec. 14, 2021

(30) Foreign Application Priority Data
Nov. 25, 2019 (JP) 2019-212538

(51) Int. Cl. A43D 1/02; A43D 3/02

(52) U.S. Cl. CPC A43D 1/025; B27M 3/20; A43D 3/02

(57) ABSTRACT

A method of manufacturing a custom order shoe includes steps of a last making step for producing a last based on the customer's foot data, a shoe upper knitting and shaping step for sewing an upper fabric by three-dimensional shaped knitting and keeping the shape of an upper part in a state where the last is inserted, and a shoe completing step for selectively attaching an insole and an outsole to the upper part.

### TECHNICAL FIELD

The present invention relates to a method of manufacturing custom order shoes (i.e., custom-made shoes or made-to-measure shoes) capable of not only shortening manufacturing time and reducing cost, but also providing a fit feeling suitable for a customer's feet.

### BACKGROUND ART

Regarding the conventional shoe manufacturing or sales systems, prior arts are as follows.

Japanese Patent Application Laid-Open No. 2018-194945 (Patent Document 1) proposes a shoe manufacturing system, a shoe manufacturing method, and a computer program for shoe manufacturing operation that can efficiently cope with a complex and diverse process of each vendor, and can realize total management including order management.

Further, Japanese Patent Application Laid-Open Publication No. 2018-165979 (Patent Document 2) discloses an information processing apparatus, an information processing method, and a program for providing a new method capable of matching equally and easily, even in an item of unstandardized shape.

Moreover, Japanese Patent Application Laid-Open Publication No. 2003-108795 (Patent Document 3) discloses an order receiving and sales business system for order shoes as a service business model that can be easily used by establishing foot-type measuring stations nationwide.

On the other hand, the upper knitting or molding technique of the conventional shoe has been disclosed as follows.

Japanese Patent Application Laid-Open Publication No. 2016-83110 (Patent Document 4) discloses a method of knitting a shoe upper providing a knitting method capable of making a heel portion into a more wrapped shape.

Further, Japanese Patent Laid-Open Publication No. 2018-166881 (Patent Document 5) discloses a shoe upper and a shoe using said shoe upper, in which a reinforcing member can be disposed at a predetermined position without limiting the appearance of the shoe, and hardly making the user feel uncomfortable.

In addition, WO2014/203585 (Patent Document 6) discloses a method for manufacturing a shoe upper capable of manufacturing a shoe upper having a double-layer structure with good productivity.

### PRIOR-ART DOCUMENTS

### Patent Literature

Patent Document 1: JP-A-2018-194945

Patent Document 2: JP-A-2018-165979

Patent Document 3: JP-A-2003-108795

Patent Document 4: JP-A-2016-083110

Patent Document 5: JP-A-2018-166881

Patent Document 6: International Publication WO2014/203585

### SUMMARY OF INVENTION

### Problems to be Solved by Invention

However, the conventional shoe manufacturing or sales system merely matches a shoe closest to a human foot based on data obtained by a foot-type measurement 3D scanner, and it is only intended to align the human foot with the shoe of the mass-produced product standard. In addition, the shoe using conventional knit fabrics has a problem in that many cutting and sewing processes are used, including complicated processes that are not compatible with a custom order service.

Hence, the present invention has been developed by the inventor in view of the above problems, and it aims to provide a method for manufacturing custom order shoes capable of shortening the manufacturing time, reducing the cost, and provide a fit feeling suitable for the customer's feet.

### Means for Solving Problem

In order to solve the above-mentioned problems, the present invention includes: a customer's foot-type measuring means in a store, a last making means in a wooden last factory, an upper part making means in a sock factory, and a sole part making means in a shoe factory. It also includes: a wooden-last making step for making the last to fit the customer's foot on the basis of the customer's foot type data; a shoe upper knitting and molding step for sewing the upper fabric by three-dimensional knitting, and then holding the upper part in a state where the above-mentioned last is inserted, and a shoe completing step for selectively attaching an insole and an outsole to the upper part. By coordinating the above-mentioned steps, it is possible to make a shoe in a short period of time and provide a shoe having a fit feeling suitable to the customer's foot.

Further, the wooden-last making step of the present invention is characterized in that it includes a step of producing a standard last corresponding to a pattern order.

Further, the shoe upper knitting and molding step of the present invention is characterized in that the upper fabric is knitted into a three-dimensional shape by a circular knitting machine using a fused yarn, and in a state where the last is inserted, the fused yarn knitted into the upper fabric is heated and melted, and then cooled and fixed to maintain the upper part.

Further, the shoe completing step of the present invention is characterized in that the outsole is processed in a state where the last is inserted into the upper part.

### Effect of Invention

As described above, in the method of manufacturing a custom order shoe according to the present invention, by employing the step of making a standard last corresponding to a pattern order, it is possible to select an optimal combination of last not only from the full custom orders but also from the customer's foot type data, and it is possible to shorten the manufacturing time and reduce the cost. It is also characterized by producing no disposal inventory and few waste materials due to the custom order. Furthermore, by devising a method of organizing the upper part and eliminating scrap materials, business activities can be carried out environmentally friendly.

In addition, by adopting a shoe upper knitting and molding step in which the upper part is kept in a state where the last is inserted after sewing the upper fabric by three-dimensional molding knitting, types of shoe sizes can be reduced because it can correspond to a certain range of sizes like socks. In addition, since the upper part is kept in shape by using the last, the operation can be streamlined.

In addition, by employing the shoe completing step of selectively attaching the insole and the outsole to the upper part, it is possible to provide a custom order shoe according to the application.

### BRIEF DESCRIPTION OF DRAWINGS

FIG. 1 is an explanatory diagram showing an outline of the manufacturing and sales business of the custom order shoes.

FIG. 2 is a flow chart showing an example of the shoe manufacturing process according to the present invention.

FIG. 3 shows an example of a left foot last produced by the wooden-last making step according to the present invention, where (a) is a perspective view, (b) is a left-side view, (c) is a right-side view, and (d) is a bottom view.

FIG. 4 shows an example of an upper part knitted in the shoe upper knitting and molding step according to the present invention, where (a) is a front view, and (b) is a side view.

FIG. 5 is an explanatory view showing an example of the sewing procedure of the upper part shown in FIG. 4.

FIG. 6 shows an example of a state where a left foot last shown in FIG. 3 is inserted in the upper part shown in FIG. 4, where (a) is a perspective view, (b) is a left-side view, (c) is a right-side view, and (d) is a bottom view.

FIG. 7 is an explanatory view showing an example of a shoe completing step according to the present invention.

### DETAILED DESCRIPTION OF EMBODIMENT

An embodiment of the present invention will be described below with reference to the drawings. Note that each configuration of the method of manufacturing a custom order shoe according to the present invention is not limited to the following examples and can be appropriately modified depending on the usage condition.

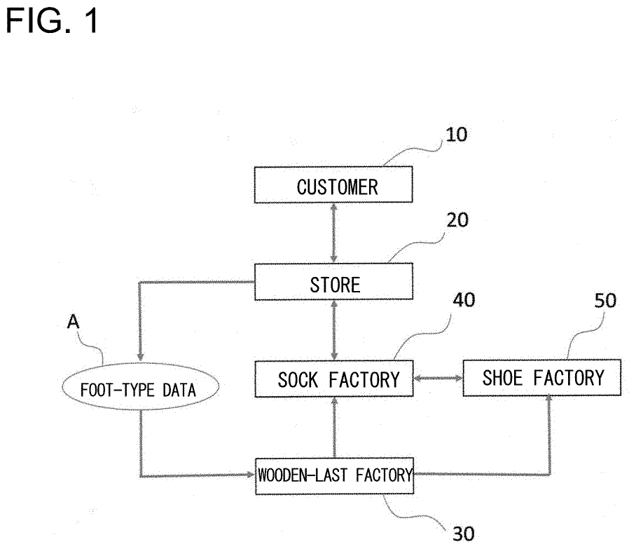

FIG. 1 is an explanatory diagram showing an outline of the manufacturing and sales business of the custom order shoes. Instead of fitting feet to shoes, this business aims to provide the best shoes for customers at a reasonable price. As will be described later, it includes a means of measuring the foot-type of a customer 10 in a store 20, a means of producing last based on the foot-type data A in a wooden-last making factory 30, a means of producing an upper part in a sock factory 40, and a means of producing sole part in a shoe factory 50.

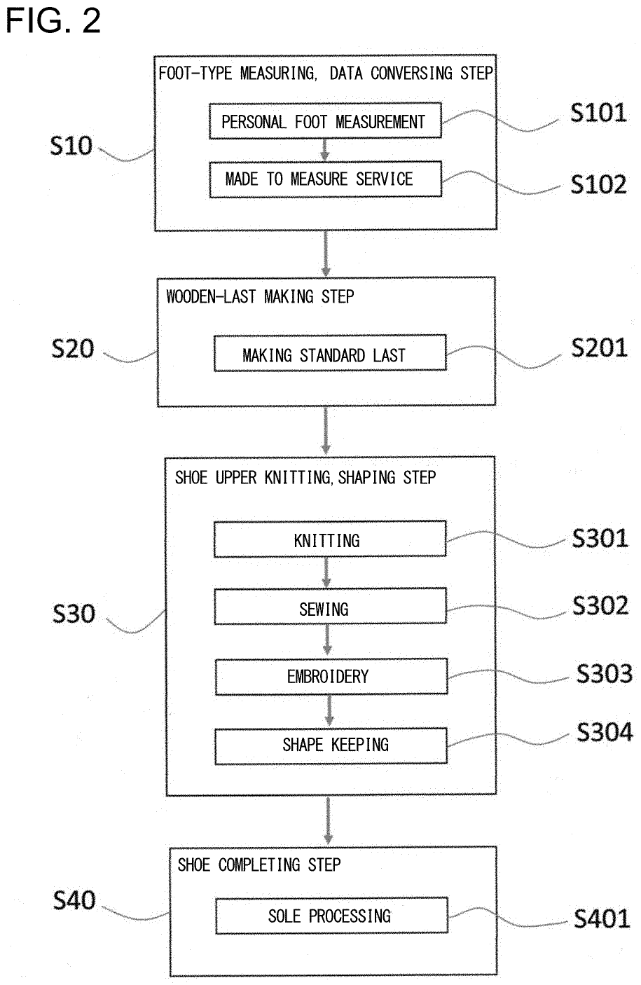

Further, FIG. 2 is a flow chart illustrating an example of the shoe manufacturing process according to the present invention. As shown in FIG. 2, the shoe manufacturing process includes: a foot-type measuring and data conversing step (S10) for measuring the foot type of the customer and converting the information into data, a wooden-last making step (S20) for producing a last that matches the foot of the customer based on the foot type data of the customer, a shoe upper knitting and shaping step (S30) for sewing the upper fabric by three-dimensional shaped knitting and then holding the upper part in a state where the last is inserted, and a shoe completing step (S40) for selectively attaching the insole and the outsole to the upper part. The shoe manufacturing process is characterized in that, by coordinating the respective steps (S10, S20, S30, and S40), it is possible to speedily provide the shoes having a fit feeling that matches the feet of the customer.

(S10: Foot-Type Measuring and Data-Conversing Step)

To enable custom-made, individual foot-type measurement is performed using a 3D foot-type measurement device (FIG. 2: S101). By making a shaved-out wooden last based on the obtained scanned data, it is possible to make a wooden last according to the full custom-made. On the other hand, by dividing the foot type corresponding to the shoe application, the posture habit, and the motor function of the customer into several elements (foot length, foot width, foot circumference, etc.) based on the obtained scanned data, and preparing the respective options, pattern order or made-to-measure becomes possible. (FIG. 2: S102).

Here, as an example of the pattern order, certain types of wooden last are produced in advance based on the idea that if the allowable fitting range of one shoe is assumed to be a foot length of ±2.5 mm and a foot circumference of ±3 mm. In the case of a man, the foot length is extended from 235 mm to 280 mm, and the foot width is extended from C to 4E, and in the case of a woman, the foot length is extended from 210 mm to 250 mm, and the foot width is extended from B to 3E, then the foot of 60 types for men, 54 types for women, and 114 types of wooden lasts can cover 90% or more of the foot of both men and women. In addition, by selecting optimal combinations for the customer's foot type from 3D foot type scanned data, the production time can be shortened and the costs of producing a wooden last without versatility can be reduced.

(S20: Wooden Last Making Step)

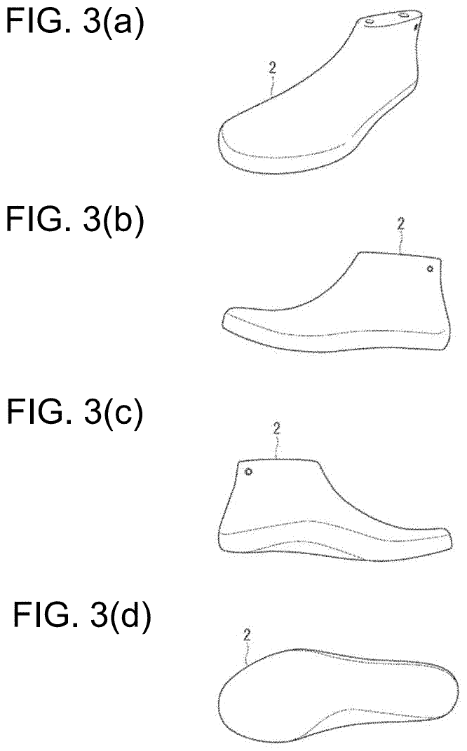

To enable custom-made, a wooden last tailored to the customer's foot is produced on the basis of the customer's foot type data (see FIG. 3). On the other hand, in the step (FIG. 2: S201) of producing a standard last corresponding to the pattern order, according to the concept of the correspondence example of the pattern order described above, 91 types for men and 79 types for women, totaling 170 types (covering 90% or more of both men and women), and 340 standard lasts for the left and right are manufactured and managed using two elements of foot length and foot circumference as indexes.

(S30: Shoe Upper Knitting and Shaping Step)

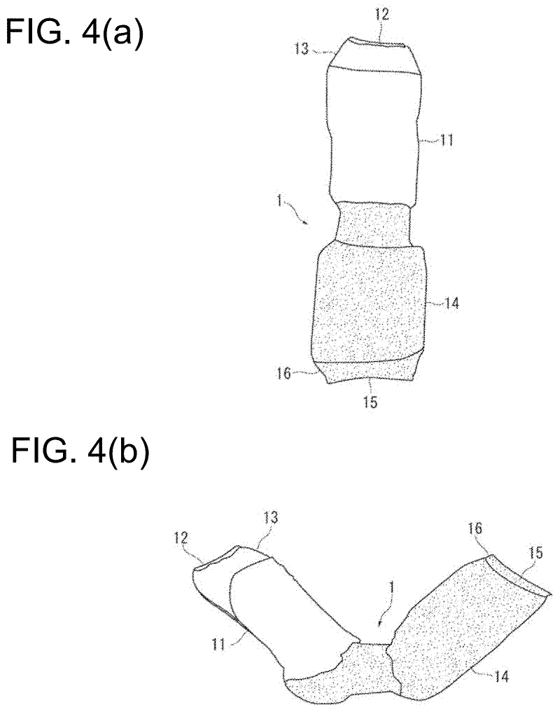

First, the upper fabric is knitted into a three-dimensional shape by a circular knitting machine using fused yarn. Specifically, the knitted fabric is simultaneously knitted with a polyester-processed yarn on the front and a fused yarn on the back (FIG. 2: S301). As shown in FIG. 4, an upper part 1 comprises an outer fabric 11 and an inner fabric 14 continuous therewith and has openings 12 and 15 at both ends of each fabric. In addition, the figure design is expressed by the outer fabric 11, and the inner fabric 14 is basically made plain. Thus, sewing can be minimized by applying the three-dimensional shaped knitting to the upper part 1. In addition, by knitting the fused yarn into the fabric to form a double structure, the fused yarn does not contact with the skin side, and it is also useful for maintaining the intensity of the shoe.

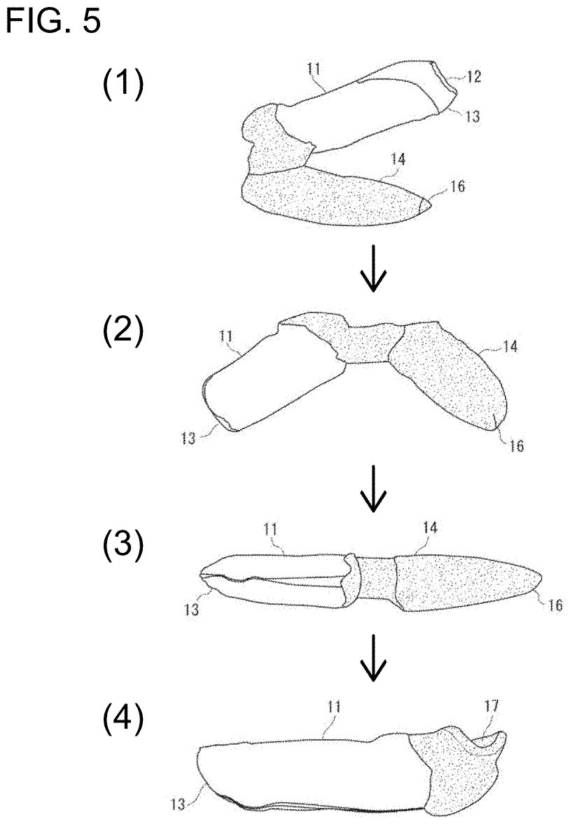

Next, as shown in FIG. 5 at (1) and (2), a toe part 16 of the inner fabric 14 and a toe part 13 of the outer fabric 11 are sewn and closed. As shown in FIG. 5 at (3) and (4), the inner fabric 14 is inserted into the inside of the outer fabric 11 (FIG. 2: S302). In addition, the outer fabric 11 and the inner fabric 14 are fastened by fitting a frame to an open footwear 17 shown in FIG. 5 (4). At this time, embroidery can be applied to the footwear 17, as shown in FIG. 2: S303.

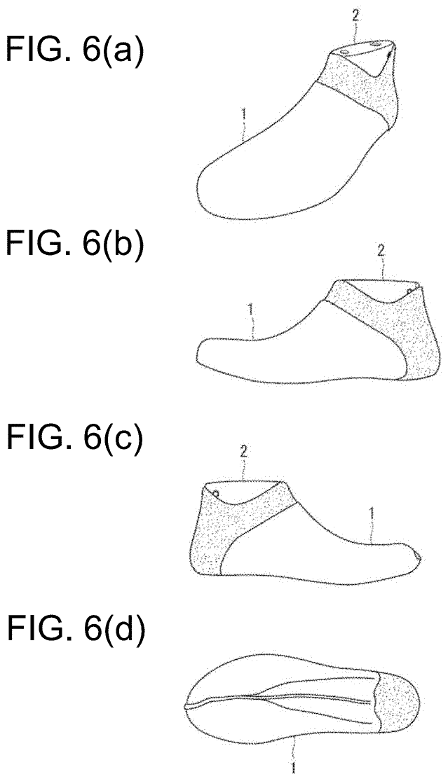

Finally, in a state of inserting the last 2 in the upper part 1 (see, FIG. 6) to hold the upper part by cooling and fixing after heating and melting the fused yarn knitted into the upper fabric (FIG. 2: S304). As described above, by employing the step of keeping the shape by heating and cooling in the state where the last 2 is inserted into the three-dimensionally shaped upper part 1 (see FIG. 6), the ultimate fit feeling that matches the foot of an individual, which not present in a conventional shoe can be obtained.

In addition, in the shoe upper knitting and shaping step, a yarn selected from a yarn obtained by subjecting the upper fabric to an antifouling treatment consisting of a polyester processed yarn or a nylon processed yarn on the surface, a short fiber spun yarn, a high strength yarn or a combination thereof may be used, and the yarn may be knitted into a three-dimensional shape by a circular knitting machine using a fused yarn on the back. Using the antifouling yarn can make the shoe resistant to fouling. Further, using short fiber spun yarn also makes it possible to create a more casual atmosphere. Furthermore, by using a high strength yarn for the toe or heel, it is possible to produce a tough shoe with higher strength, and by using a knit shaped upper knitted by a circular knitting machine, it is possible to expect wider versatility of the upper part.

(S40: Shoe Completing Step)

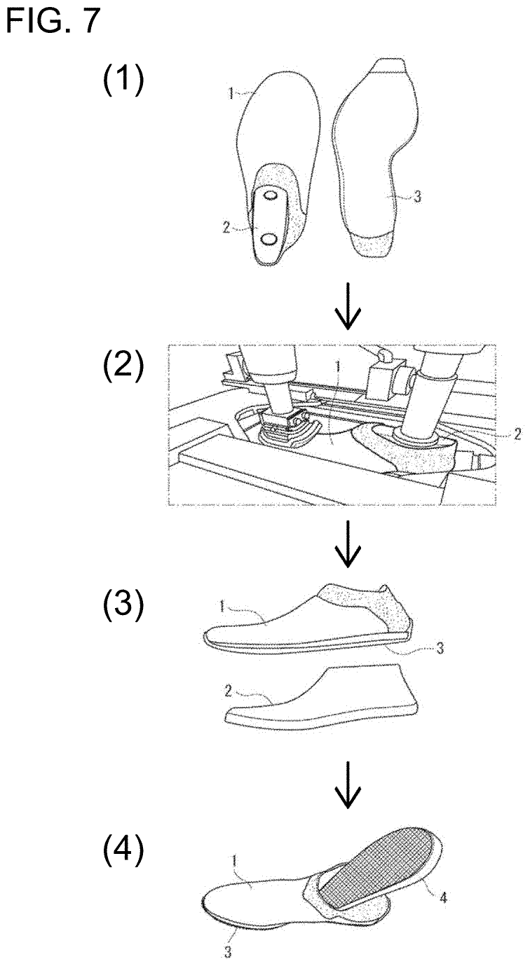

As shown in FIG. 7 at (1), (2), and (3), an outsole 3 suitable for the customer is stuck with an adhesive in a state where the last 2 is inserted into the upper part 1. Further, as shown in FIG. 7 (4), an insole 4 that matches the wearing feeling of the customer is inserted and the shoe is completed (FIG. 2: S401). Thus, by providing choices for the insole and outsole, it is possible to customize shoes that match the intended use.

### INDUSTRIAL APPLICABILITY

Practical application to medical applications such as rehabilitation applications prescribed in treatment hospitals, etc., and specific applications such as professional athletes of sports competitions are considered.

### LIST OF REFERENCE CHARACTERS

1 Upper part
11 Outer fabric
12 Opening
13 Toe part
14 Inner fabric
15 Opening
16 Toe part
17 Opening for wearing
2 Last
3 Outsole
4 Insole

1. A method for manufacturing a custom order shoe in a shoe manufacturing system comprising: a means for measuring a customer's foot-type in a store; a means for producing a last in a last factory; a means for producing an upper part in a sock factory; and a means for producing a sole part in a shoe factory, the method for manufacturing a custom order shoe comprising:
a last making step for producing a last that fits the customer's foot based on the customer's foot data;
a shoe upper knitting and shaping step for three-dimension shaped knitting the upper fabric and holding the upper part in a state where the last is inserted, and
a shoe completing step for attaching an insole and an outsole to the upper part selectably, wherein
the shoe upper knitting and shaping step includes knitting the upper fabric into a three-dimensional shape by a circular knitting machine using a polyester processed yarn on the surface and a fused yarn on the back, the upper part being made of the outer fabric and the inner fabric continuous therewith, after sewing and closing the toe part of the inner fabric and the outer fabric, inserting the inner fabric into the inner side of the outer fabric, then fitting a frame to the opening to fix the outer fabric and the inner fabric, lastly, shape keeping the upper part by cooling and fixing after heating and fusing the fused yarn knitted into the upper fabric in a state where the last is inserted in the upper part, and
the shoe completing step includes processing the outsole in a state where the last is inserted in the upper part.

2. The method according to claim 1, wherein in the shoe upper knitting and shaping step, a yarn selected from an antifouling treatment yarn made of a polyester processed yarn or a nylon processed yarn, and a short fiber spun yarn, a high strength yarn, or a combination thereof is used on the surface of the upper fabric, a fused yarn is used on the back and knitted into a three-dimensional shape by the circular knitting machine.

3. The method according to claim 1, wherein the last making step includes a step of making standard lasts corresponding to pattern orders, and the standard lasts includes 91 types for men, 79 types for women, that is 170 types in total, and 340 pieces for the left and right with two elements of foot length and foot circumference as indexes.

4. The method according to claim 2, wherein the last making step includes a step of making standard lasts corresponding to pattern orders, and the standard lasts includes 91 types for men, 79 types for women, that is 170 types in total, and 340 pieces for the left and right with two elements of foot length and foot circumference as indexes.
